(19) United States
(12) Patent Application Publication
(10) Pub. No.: US 2026/0081200 A1
(43) Pub. Date: Mar. 19, 2026

(54) APPARATUS AND METHOD FOR MANUFACTURING SECONDARY BATTERY

(71) Applicant: SAMSUNG SDI CO., LTD., Yongin-si (KR)

(72) Inventors: Kyeongseon YOO, Yongin-si (KR); JungHyuk Kim, Yongin-si (KR)

(21) Appl. No.: 19/227,662

(22) Filed: Jun. 4, 2025

(30) Foreign Application Priority Data
Sep. 13, 2024 (KR) 10-2024-0125946

(51) Int. Cl. H01M 10/04

(52) U.S. Cl. CPC H01M 10/0404; H01M 10/0422; H01M 10/0481

(57) ABSTRACT

An apparatus for manufacturing a secondary battery and a method for manufacturing a secondary battery using the apparatus, the apparatus for manufacturing a secondary battery including a rod extending in a longitudinal direction and a tab pressing portion at an end portion of the rod having a relatively higher heat resistance than the rod.

### CROSS-REFERENCE TO RELATED APPLICATION

The present application claims priority to and the benefit of Korean Patent Application No. 10-2024-0125946, filed on Sep. 13, 2024, in the Korean Intellectual Property Office, the entire disclosure of which is incorporated herein by reference.

### BACKGROUND

### 1 Field

Embodiments relate to an apparatus and method for manufacturing a secondary battery.

### 2. DESCRIPTION OF THE RELATED ART

Unlike primary batteries that cannot be charged, secondary batteries are batteries that can be charged and discharged. A secondary battery largely includes an electrode assembly including a positive electrode plate, a separator, and a negative electrode plate, a case (or can) for accommodating the electrode assembly, and an external terminal for connecting the electrode assembly to an external power source and a load.

Positive and negative electrode tabs are formed in the electrode assembly, and these electrode tabs or related members (e.g., a current collector, a connection member, auxiliary tabs, etc.) are electrically connected to positive and negative electrode terminals or related members (e.g., a rivet terminal, a cap plate, etc.) located externally.

Meanwhile, when prismatic or circular secondary batteries are manufactured, a negative electrode tab of a jelly-roll is laser welded to a bottom surface of a case, and for good welding, it is important that the electrode tab should be in close contact with the bottom surface. Thus, the electrode tab is pressurized and pressed against the bottom surface using a separate pusher.

The above information disclosed in this Background section is for enhancement of understanding of the background of the present disclosure, and therefore, it may contain information that does not constitute a related (or prior) art.

### SUMMARY

Embodiments are directed to an apparatus for manufacturing a secondary battery, the apparatus including a rod extending in a longitudinal direction, and a tab pressing portion at an end portion of the rod having a relatively higher heat resistance than the rod.

The rod may include an extension rod in a form of a rectilinearly extending metal rod, and the tab pressing portion may include a push head made of a ceramic material fixed to an end portion of the extension rod.

The ceramic material may include alumina, zirconia, barium titanate, silicon nitride, tungsten carbide, magnesia, or silicon carbide.

The push head may be a structure laminated on the end portion of the extension rod in a coating manner.

An irregular portion for expanding a close contact area of the push head to the extension rod may be at the end portion of the extension rod.

The push head may be a molded product manufactured by a sintering molding method and may be mounted on and fixed to the end portion of the extension rod.

A cross section of the extension rod may be a circular shape or a polygonal shape.

A shape of a bottom surface of the push head may be an elliptical shape, a circular shape, or a polygonal shape.

The push head may be fixed to the extension rod through an adhesive.

A thermally conductive stacked body may be between the push head and the extension rod.

The thermally conductive stacked body may include carbon nanotubes or diamond-like carbon.

The apparatus according to some embodiments may further include an adapter between the extension rod and the push head configured to couple the push head to the extension rod.

The adapter may be fixed to the push head and may be detachably coupled to the extension rod.

The extension rod and the adapter may be screw-coupled.

The end portion of the extension rod may include a coupling groove, the adapter may include an inserting protrusion, and the inserting protrusion may be in the coupling groove.

The extension rod may include a hollow rod or a solid rod.

The extension rod may include a plurality of unit rods.

Embodiments are directed to a method of manufacturing a secondary battery, the method including preparing a pushing unit having a rod extending in a longitudinal direction and passing through a space portion of an electrode assembly, and a tab pressing portion positioned in an end portion of the rod having a relatively higher heat resistance than the rod and pressing an electrode tab of the electrode assembly to a welding target surface and bringing the electrode tab into close contact with the welding target surface, inserting the pushing unit into a case of the secondary battery accommodating the electrode assembly to press the electrode tab of the electrode assembly to be in close contact with a bottom of the case, and welding the electrode tab to the bottom of the case.

The tab pressing portion may be made of a ceramic material, and preparing the pushing unit may include coating the end portion of the rod with the ceramic material.

The tab pressing portion may be made of a ceramic material, and preparing the pushing unit may include coupling a molded product manufactured by a sintering molding method to the end portion of the rod.

### BRIEF DESCRIPTION OF THE DRAWINGS

Features will become apparent to those of skill in the art by describing in detail exemplary embodiments with reference to the attached drawings in which:

FIG. 1 is a cross-sectional view illustrating a secondary battery manufactured by an apparatus for manufacturing a secondary battery according to some embodiments of the present disclosure;

FIGS. 2A and 2B are diagrams illustrating a state in which an electrode tab is fixed to a case using the apparatus for manufacturing a secondary battery according to some embodiments of the present disclosure;

FIGS. 3A to 3D are diagrams for describing a method of manufacturing a secondary battery using the apparatus for manufacturing a secondary battery according to some embodiments of the present disclosure;

FIGS. 4A to 4C are perspective views illustrating a pushing unit separated from the apparatus for manufacturing a secondary battery according to some embodiments of the present disclosure;

FIGS. 5A to 5F are cross-sectional views illustrating various modified embodiments of the pushing unit shown in FIG. 4;

FIGS. 6 to 8 are partial cross-sectional views illustrating various implementations of the pushing unit shown in FIG. 2A;

FIGS. 9A to 9C are partial cross-sectional views illustrating other embodiments of the pushing unit;

FIGS. 10 to 12 are partial cross-sectional views illustrating still other embodiments of the pushing unit;

FIG. 13 is a diagram illustrating yet another embodiment of the pushing unit;

FIG. 14 is a diagram illustrating yet another embodiment of the pushing unit;

FIGS. 15A and 15B are diagrams illustrating modified embodiments of an extension rod in the pushing unit according to some embodiments of the present disclosure; and

FIG. 16 is a flowchart illustrating a method of manufacturing a secondary battery according to some embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe his/her invention in the best way.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified. As used herein, the term “or” is not necessarily an exclusive term, e.g., “A or B” would include A, B, or A and B.

The terminology used herein is for the purpose of describing embodiments of the present disclosure and is not intended to limit the present disclosure.

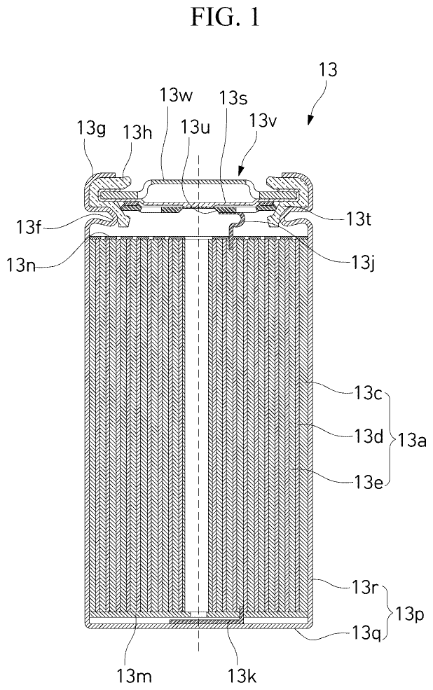

FIG. 1 is a cross-sectional view illustrating a cylindrical secondary battery 13 manufactured by an apparatus for manufacturing a secondary battery according to some embodiments of the present disclosure. In an implementation, the manufacturing apparatus of the present disclosure can also be used for manufacturing prismatic secondary batteries.

As shown in FIG. 1, the secondary battery 13 may include an electrode assembly 13a, a case 13p accommodating the electrode assembly 13a and an electrolyte therein, a cap assembly 13v coupled to an opening of the case 13p to seal the case 13p, and an insulating plate 13n between the electrode assembly 13a and the cap assembly 13v inside the case.

The electrode assembly 13a may include a separator 13d and a first electrode 13c and a second electrode 13e with the separator therebetween and may be wound in a jelly-roll shape.

The first electrode 13c may include a first substrate and a first active material layer on the first substrate. A first electrode tab 13j may extend outwardly from a first uncoated portion of the first substrate where the first active material layer is not located, and the first electrode tab 13j may be electrically connected to the cap assembly 13v.

The second electrode 13e may include a second substrate and a second active material layer on the second substrate. A second electrode tab 13k may extend outwardly from a second uncoated portion of the second substrate where the second active material layer is not located, and the second electrode tab 13k may be electrically connected to the case. The first electrode tab 13j and the second electrode tab 13k may extend in opposite directions.

The first electrode 13c may act as a positive electrode. In such an embodiment, the first substrate may be made of, e.g., aluminum foil, and the first active material layer may include, e.g., a transition metal oxide. The second electrode 13e may act as a negative electrode. In such an embodiment, the second substrate may be made of, e.g., copper foil or nickel foil, and the second active material layer may include, e.g., graphite.

The separator 13d may help prevent a short circuit between the first electrode and the second electrode while allowing movement of lithium ions therebetween. The separator 13d may be made of, e.g., a polyethylene film, a polypropylene film, a polyethylene-polypropylene film, or the like.

The case 13p may accommodate the electrode assembly 13a and, together with the cap assembly 13v, may form the external appearance of the secondary battery. The case 13p may have a substantially cylindrical body portion 13r and a bottom portion 13q connected to one side (e.g., to one end) of the body portion 13r. A beading part 13f (e.g., a bead) deformed inwardly may be formed in the body portion 13r, and a crimping part 13g (e.g., a crimp) bent inwardly may be formed at an open end of the body portion 13r.

The beading part 13f may help reduce or prevent movement of the electrode assembly 13a inside the case 13p and may help facilitate seating of the gasket 13h and the cap assembly 13v. The crimping part 13g may help firmly fix the cap assembly 13v by pressing the edge of the case 13p against the gasket 13h. The case 13p may be formed of, e.g., iron plated with nickel.

The cap assembly 13v may be fixed to the inside of the crimping part 13g by a gasket 13h to seal the case 13p. The cap assembly 13v may include a cap up 13w, a safety vent 13s, a cap down 13t, an insulating member, and a sub plate 13u.

The cap up 13w may be at the uppermost part of the cap assembly 13v. The cap up 13w may include a terminal part that protrudes upwardly and is connected to an external circuit, and an outlet for discharging gas may be arranged around the terminal part.

The safety vent 13s may be located under the cap up 13w. The safety vent 13s may include a protrusion part that protrudes convexly downwardly and is connected to the sub plate 13u, and at least one notch may be formed in the safety vent around the protrusion part.

If gas is generated due to overcharging or abnormal operation of the secondary battery, the protrusion part may be deformed upwardly by the pressure and may separate from the sub plate 13u while the safety vent 13s is cut (e.g., bursts or tears) along the notch. The cut safety vent 13s may help prevent the secondary battery from exploding by allowing for the gas to be discharged to the outside.

The cap down 13t may be below the safety vent 13s. The cap down 13t may have a first opening exposing the protrusion part of the safety vent 13s and a second opening allowing for gas discharge. The insulating member may be between the safety vent 13s and the cap down 13t to help insulate the safety vent 13s and the cap down 13t.

The sub plate 13u may be under the cap down 13t. The sub plate 13u may be fixed to a lower surface of the cap down 13t and may help block the first opening of the cap down 13t, and the protrusion part of the safety vent 53 may be fixed to the sub plate 13u. The first electrode tab 13j, which may be drawn out from (e.g., extend from) the electrode assembly 13a may be fixed to the sub plate 13u. In an implementation, the cap up 13w, the safety vent 13s, the cap down 13t, and the sub plate 13u may each be electrically connected to the first electrode 13c of the electrode assembly 13a.

The insulating plate 13n may be in contact with the electrode assembly 13a below the beading part 13f. The insulating plate 13n may have a tab opening through which the first electrode tab 13j is drawn out. The cap assembly 13v, which may be electrically connected to the first electrode by the first lead tab, may face the electrode assembly with an insulating plate 13n therebetween and may maintain a state of being insulated (e.g., electrically insulated) from the electrode assembly 13a by the insulating plate 13n. Meanwhile, another insulating plate 13m may be included for insulation between the electrode assembly 13a and the bottom portion 13q of the case 13p.

Hereinafter, suitable materials that may be usable for the secondary battery according to embodiments of the present disclosure will be described.

As the positive electrode active material, a compound capable of reversibly intercalating/deintercalating lithium (e.g., a lithiated intercalation compound) may be used. In an implementation, a composite oxide of lithium and a metal, e.g., cobalt, manganese, nickel, or combinations thereof may be used.

The composite oxide may be a lithium transition metal composite oxide, and examples thereof may include, e.g., a lithium nickel oxide, a lithium cobalt oxide, a lithium manganese oxide, a lithium iron phosphate compound, a cobalt-free nickel-manganese oxide, or a combination thereof.

In an implementation, a compound represented by one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); or LiₐFePO₄ (0.90≤a≤1.8).

In the above formulas: A may be, e.g., Ni, Co, Mn, or a combination thereof; X may be, e.g., Al, Ni, Co, Mn, Cr, Fe, Mg, Sr, V, a rare earth element, or a combination thereof; D may be, e.g., O, F, S, P, or a combination thereof; G may be, e.g., Al, Cr, Mn, Fe, Mg, La, Ce, Sr, V, or a combination thereof; and L¹ may be, e.g., Mn, Al, or a combination thereof.

A positive electrode for a lithium secondary battery may include a substrate and a positive electrode active material layer on the substrate. The positive electrode active material layer may include a positive electrode active material and may further include a binder and/or a conductive material.

The content of the positive electrode active material may be in a range of about 90 wt % to about 99.5 wt %, based on 100 wt % of the positive electrode active material layer, and the content of the binder and the conductive material is in a range of about 0.5 wt % to about 5 wt %, respectively, based on 100 wt % of the positive electrode active material layer.

The substrate may be aluminum (Al).

The negative electrode active material may include, e.g., a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, e.g., crystalline carbon, amorphous carbon, or a combination thereof. In an implementation the crystalline carbon may be or include graphite, e.g., natural graphite or artificial graphite, and the amorphous carbon may be or include, e.g., soft carbon, hard carbon, a pitch carbide, a meso-phase pitch carbide, sintered coke, or the like.

In an implementation, a Si-based negative electrode active material or a Sn-based negative electrode active material may be used as the material capable of being doped and undoped with lithium. The Si-based negative electrode active material may be, e.g., silicon, a silicon-carbon composite, SiOₓ (0<x<2), a Si-based alloy, or a combination thereof.

The silicon-carbon composite may be, e.g., a composite of silicon and amorphous carbon. In an implementation, the silicon-carbon composite may be in the form of a silicon particle and amorphous carbon coated on the surface of the silicon particle.

The silicon-carbon composite may further include crystalline carbon. In an implementation, the silicon-carbon composite may include a core including crystalline carbon and silicon particles and an amorphous carbon coating layer on the surface of the core.

In an implementation, a negative electrode for a lithium secondary battery may include a substrate and a negative electrode active material layer on the substrate. The negative electrode active material layer may include a negative electrode active material and may further include a binder or a conductive material.

In an implementation, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode substrate, copper foil, nickel foil, stainless steel foil, titanium foil, nickel foam, copper foam, conductive metal-coated polymer substrate, or combinations thereof may be used.

An electrolyte for a lithium secondary battery may include a non-aqueous organic solvent and a lithium salt.

The non-aqueous organic solvent may act as a medium through which ions involved in the electrochemical reaction of the battery can move.

The non-aqueous organic solvent may be or include, e.g., a carbonate-based, an ester-based, an ether-based, a ketone-based, an alcohol-based solvent, an aprotic solvent, and may be used alone or in combination of two or more.

In an implementation, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

In an implementation, the separator may include a porous substrate and a coating layer including an organic material, an inorganic material, or a combination thereof on one or both surfaces of the porous substrate.

The organic material may include, e.g., a polyvinylidene fluoride-based polymer or a (meth)acrylic polymer.

The inorganic material may include inorganic particles, e.g., Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or combinations thereof.

The organic material and the inorganic material may be mixed in one coating layer or may be in the form of a coating layer including (or containing) an organic material and a coating layer including (or containing) an inorganic material that are stacked on each other.

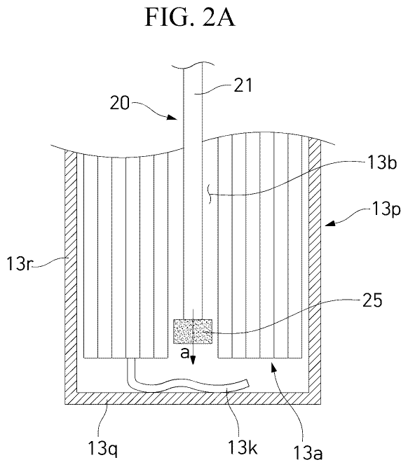

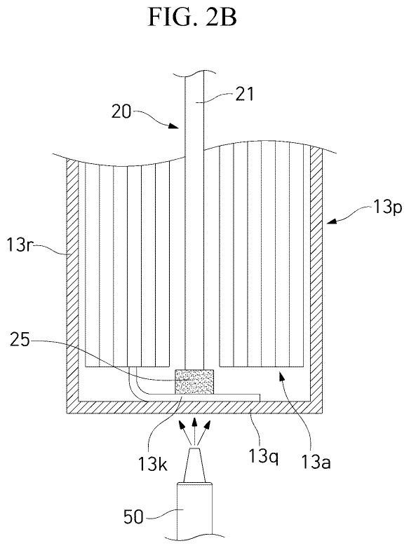

FIGS. 2A and 2B are diagrams illustrating a state in which an electrode tab is fixed to a case using the apparatus for manufacturing a secondary battery according to some embodiments of the present disclosure.

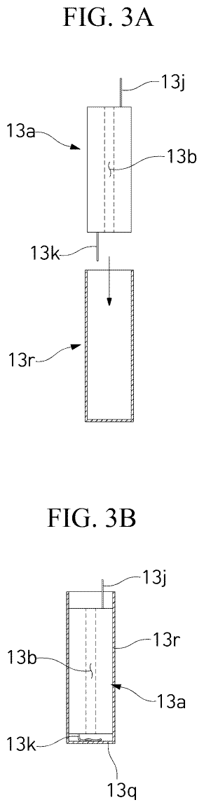

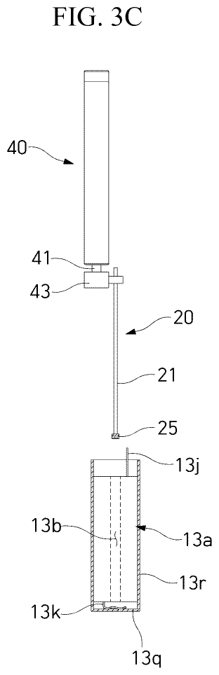

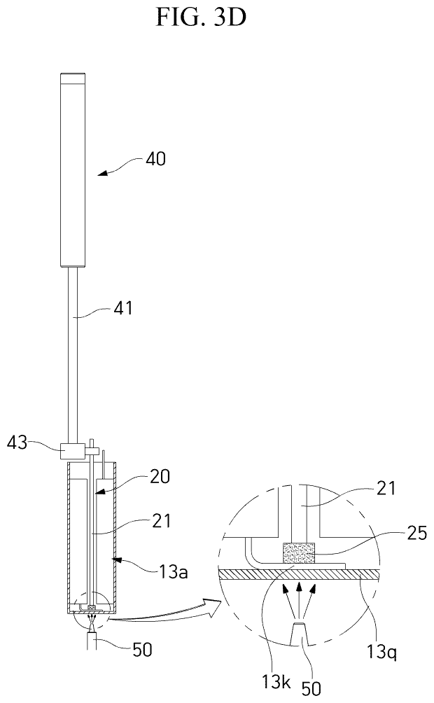

As shown in the drawing, the apparatus for manufacturing a secondary battery according to the present embodiment may include a pushing unit 20, an actuator 40 (see FIG. 3), and a welder 50. The actuator 40 may be an electronic actuator. The actuator 40 may move the pushing unit 20 up and down to predetermined levels. In an implementation, the welder 50 may help weld the second electrode tab 13k to the bottom portion 13q of the case 13p. The welder 50 may be a laser welder.

The pushing unit 20 may include a rod and a tab pressing portion. The rod may extend in a longitudinal direction and pass through a space (hollow core) of the jelly-roll type electrode assembly 13a of the secondary battery. In an implementation, the tab pressing portion may be at an end portion of the rod, and have relatively higher heat resistance than the rod, and may press the electrode tab of the electrode assembly to a welding target surface, i.e., the bottom portion 13q of the case 13p, to be in contact therewith. For example, the pushing unit 20 may include a rod extending in a longitudinal direction and a tab pressing portion at an end portion of the rod having a relatively higher heat resistance than the rod.

In some embodiments, an extension rod 21 may be applied (e.g., included as the rod). The extension rod 21 may be a straightly extending metal rod (e.g., a straight metal rod). The extension rod 21 may pass through a space portion 13b of the electrode assembly 13a. Since the shown electrode assembly 13a is the jelly-roll type electrode assembly, a central space, i.e., a hollow core, may be present. The extension rod 21 may be a steel bar.

As shown in FIG. 3D, in a state in which a lower end portion of the extension rod 21 reaches the bottom portion 13q of the case 13p, the extension rod 21 may have a length to allow an upper end portion to be exposed at an upper portion of the case 13p.

The electrode pressing part may be a push head 25 made of a ceramic material and fixed to the end portion of the extension rod 21. The push head 25 may serve to press the second electrode tab 13k by coming into close contact with an upper surface of the second electrode tab 13k.

The ceramic material constituting the push head may be made of, e.g., alumina (Al₂O₃), zirconia (ZrO₂), barium titanate (BaTiO₃), silicon nitride (Si₃N₄), tungsten carbide (WC), magnesia (MgO), or silicon carbide (SIC).

The heat-resistant temperature of the ceramic material may be about 1,500° C. or higher (the melting point may be about 2,000° C. or higher), the hardness may be about 1,000 Hv or higher, which may be about 10 to 15 times that of a metal, the abrasion resistance may be about 10 times that of steel, and heat resistance may be about 1.5 times higher than the material of the extension rod 21, so that the ceramic is hardly damaged by welding heat. If the ceramic material is used, mass production stability may be secured due to the unique characteristics of the ceramic material, e.g., thermal stability and high hardness.

By applying the push head 25 made of the ceramic material to the end portion of the extension rod 21, the lifetime of the pushing unit 20 may be extended through an improvement in hardness. If the push head 25 were omitted, the extension rod 21 may come into close contact with the second electrode tab 13k and receive the welding heat directly, and thus the end portion of the extension rod 21 may be damaged or melted. In particular, when the extension rod is melted, some of the melted material may be transferred to the second electrode tab 13k, which may cause an electrical short circuit.

Coupling of the push head 25 to the extension rod 21 will be described below.

Meanwhile, referring to FIG. 2A, it can be seen that the pushing unit 20 may be moved down in a direction of the illustrated arrow a through the space portion 13b of the electrode assembly 13a. The reason for moving the pushing unit 20 down is to press the second electrode tab 13k with the push head 25 to bring the second electrode tab 13k into close contact with the bottom portion 13q of the case 13p.

As shown in FIG. 2A, if the second electrode tab 13k is spaced from the bottom portion 13q of the case 13p, when the push head 25 presses the second electrode tab 13k downward, as shown in FIG. 2B, the second electrode tab 13k may be completely in close contact with the bottom portion 13q of the case. In a state in which the second electrode tab 13k is in close contact with the bottom portion 13q of the case 13p, coupling of the second electrode tab 13k to the bottom portion 13q of the case 13p may be performed using the welder 50.

FIGS. 3A to 3D are diagrams sequentially illustrating a process of installing the electrode assembly 13a inside the case 13p using the apparatus for manufacturing a secondary battery according to some embodiments of the present disclosure.

In order to install the electrode assembly 13a, first, as shown in FIG. 3A, the electrode assembly 13a may be inserted into the empty case 13p. The electrode assembly 13a may be a jelly-roll type electrode assembly and thus may have the space portion 13b. In an implementation, a first electrode tab 13j may be provided on an upper portion of the electrode assembly 13a, and a second electrode tab 13k may be provided on a lower portion thereof.

FIG. 3B shows the electrode assembly 13a fitted inside the case 13p. The second electrode tab 13k may be in a lower portion of the space portion 13b while pressed and folded due to a weight of the electrode assembly 13a and may wait to be welded to the bottom portion 13q of the case 13p.

In addition, referring to FIG. 3C, the pushing unit 20 may be mounted on (e.g., attached to) the actuator 40. The actuator 40 may be an electronic actuator and may have a piston rod 41 and a holder 43. The holder 43 may be moved up and down vertically by an operation of the actuator 40. An upper end portion of the extension rod 21 of the pushing unit 20 may be fixed to (e.g., attached to) the holder 43.

The pushing unit 20 may be moved up and down by the operation of the actuator while vertically above the space portion 13b of the electrode assembly 13a. In an implementation, when the pushing unit 20 is completely moved down, as shown in FIG. 3D, the pushing unit 20 may press the second electrode tab 13k to bring the second electrode tab 13k into close contact (e.g., direct contact) with the bottom portion 13q of the case 13p.

In this case, the welder 50 may be moved below the pushing unit 20 to perform welding. The welder 50 may be a laser welder. Welding heat output from the welder 50 may partially melt a close contact portion between the second electrode tab 13k and the bottom portion 13q of the case 13p to perform welding therebetween.

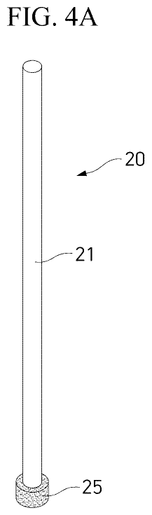

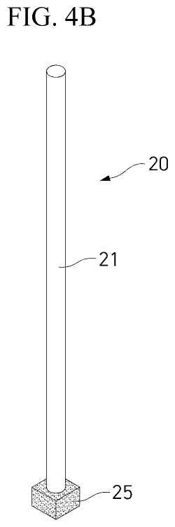

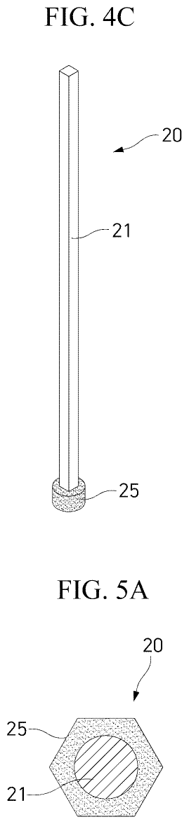

FIGS. 4A to 4C are perspective views illustrating various examples of the pushing unit 20 included in the apparatus for manufacturing a secondary battery according to some embodiments of the present disclosure.

An extension rod 21 of the pushing unit 20 shown in FIG. 4A may be a solid round bar and a push head 25 may have a cylindrical shape. A diameter and a length of the pushing unit 20 may be variously modified. An extension rod 21 of the pushing unit 20 shown in FIG. 4B may have the shape of a round bar similar to that of FIG. 4A. In an implementation, a push head 25 may have a quadrangular bottom. In an implementation, the pushing unit 20, e.g., the pushing unit 20 of FIG. 4C, may have a quadrangular-shaped extension rod 21 and a circular push head 25.

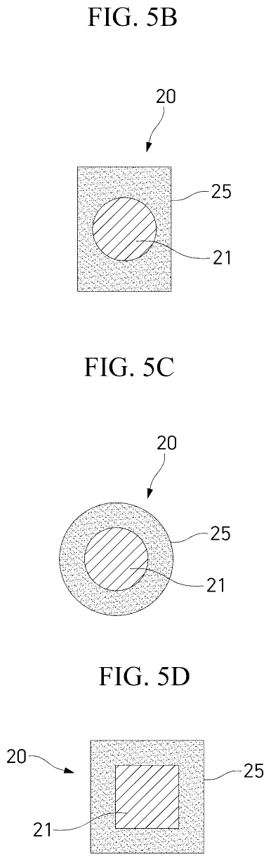

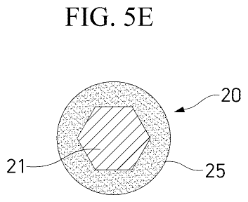

FIGS. 5A to 5F are cross-sectional views additionally illustrating various implementations of the pushing unit 20 shown in FIG. 4.

As shown in the drawings, the cross-sectional shape of the extension rod 21 may be a circular, hexagonal, or quadrangular shape. In an implementation, the extension rod 21 may be a polygonal shape other than a hexagonal or quadrangular shape.

In an implementation, the push head 25 may have a hexagonal, rectangular, circular, square, or elliptical shape. In an implementation, the push head 25 may have a shape different from the above shapes.

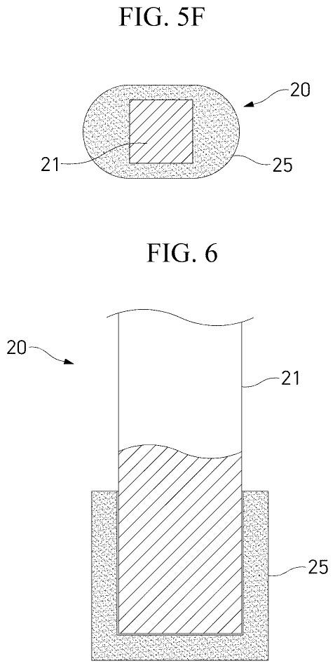

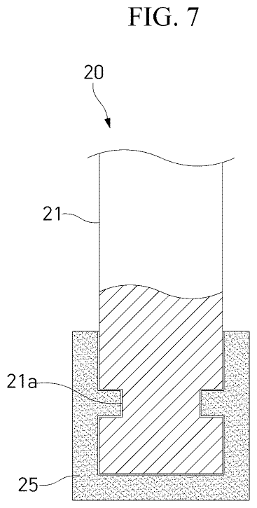

FIGS. 6 to 8 are partial cross-sectional views illustrating various implementation examples of the pushing unit 20 shown in FIG. 2A.

Referring to FIG. 6, it can be seen that a push head 25 is applied to the lower end portion of the extension rod 21 in a coating manner. The push head 25 has a structure laminated on a surface of the extension rod 21 in a coating manner. As described above, the push head 25 may be made of a ceramic material.

Various methods may be applied to the method of laminating a ceramic material on the extension rod 21. In an implementation, a ceramic material may be laminated in a wet or dry method. A wet lamination method may be a coating method of dispersing a ceramic powder in a liquid medium and laminating the ceramic powder using the dispersion liquid. The wet lamination method may include, e.g., slurry coating, sol-gel coating, and electron penetration coating. In an implementation, a dry lamination method may include, e.g., a flame method, a plasma arc method, and an explosion spray method.

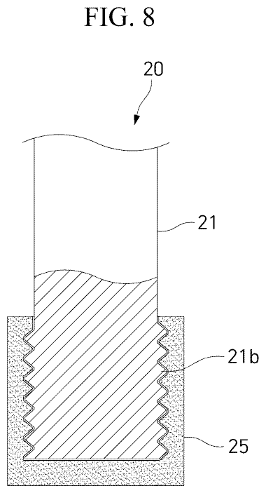

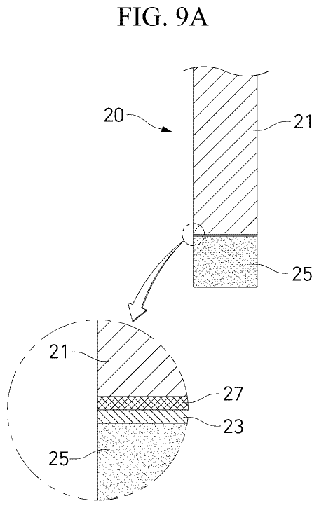

An irregularity portion may be located on an end portion of the extension rod 21 in the pushing unit 20 shown in FIGS. 7 and 8. The irregularity portion may be included in order to help expand a close contact area of the push head 25 against the extension rod 21. By including the irregularity portion, a bonding force of the push head 25 to the extension rod 21 may be significantly increased.

The irregularity portion shown in FIG. 7 may be a groove 21a extending in a circumferential direction. For example, the groove 21a may go completely around the extension rod 21. The groove 21a may be a portion formed through machining and may accommodate a portion of the ceramic material constituting the push head 25. For example, a portion of the push head 25 may be accommodated in the groove 21a. Since a portion of the push head 25 is accommodated in the groove 21a, there is no concern of the push head 25 being released from the extension rod 21.

In an implementation, the irregularity portion of FIG. 8 may be a tooth portion 21b. For example, the tooth portion 21b may extend in a circumferential direction and go completely around the extension rod 21. The tooth portion 21b may have a sawtooth shape and may be in close contact with the ceramic material constituting the push head 25. As long as the push head 25 is in close contact with the tooth portion 21b, there is no concern of the push head 25 being released from the extension rod 21.

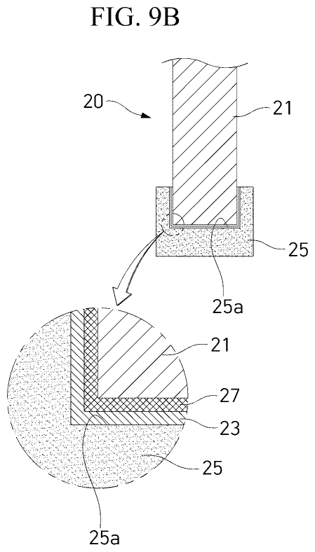

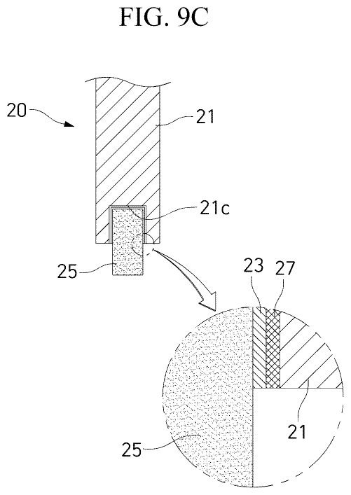

FIGS. 9A to 9C are partial cross-sectional views illustrating other examples of the pushing unit 20. The pushing unit 20 of each of FIGS. 9A to 9C may have a configuration in which a push head 25 is not applied in a coating manner, but rather a pre-molded push head is fixed using an adhesive.

As shown in FIG. 9A, a push head 25 may be fixed to the lower end portion of the extension rod 21. The push head 25 may be a product that is pre-manufactured by molding through a sintering molding method. A size of the push head 25 may be changed.

In an implementation, a thermally conductive stacked body 27 and a ceramic bond 23 may be stacked between the extension rod 21 and the push head 25.

The thermally conductive stacked body 27 may be a coating layer made of carbon nanotubes (CNTs) or diamond-like carbon (DLC). CNTs have very high thermal conductivity, and thermal conductivity of single-walled CNTs reaches 3500 W/m·K. In addition, DLC has an amorphous structure and characteristics of both diamond and graphite. Thus, by applying the thermally conductive stacked body 27, thermal conductivity may expand and thus thermal damage may be minimized.

The thermally conductive stacked body 27 may be fixed to a lower end surface of the extension rod 21 in a coating manner. In an implementation, the ceramic bond 23 may be between the thermally conductive stacked body 27 and the push head 25, and the push head 25 may be bonded to a lower portion of the thermally conductive stacked body 27. For example, the push head 25 may be directly on the ceramic bond 23, the ceramic bond 23 may be directly on the thermally conductive stacked body 27, and the thermally conductive stacked body 27 may be directly on the extension rod 21.

The pushing unit 20, e.g. as shown in FIG. 9B, may have a structure in which the lower end portion of the extension rod 21 is in a fitting groove 25a of a push head 25. The fitting groove 25a may be in an upper surface of the push head 25, e.g., as shown in FIG. 9B. The fitting groove 25a may be a groove formed according to a size of the extension rod 21 and may accommodate the lower end portion of the extension rod 21 therein. For example, when the extension rod 21 is in the fitting groove 25a, the push head 25 may completely surround an end portion of the extension rod 21.

In addition, the thermally conductive stacked body 27 and the ceramic bond 23 may be between the extension rod 21 and the push head 25. The thermally conductive stacked body 27 may be a coating layer stacked on the lower surface and a portion of an outer circumferential surface of the extension rod 21. In an implementation, the ceramic bond 23 may be between the thermally conductive stacked body 27 and the push head 25 and may fix the push head 25 to the thermally conductive stacked body 27.

For example, as in the pushing unit 20 shown in FIG. 9C, in an implementation, a portion of the push head 25 may be fitted into the lower end portion of the extension rod 21. For the coupling, a lower groove 21c may be formed in the lower end surface of the extension rod 21. The lower groove 21c may have a size for accommodating the portion of the push head 25. For example, when the push head 25 is in the lower groove 21c, the extension rod 21 may completely surround an end portion of the push head 25.

In an implementation, the thermally conductive stacked body 27 and the ceramic bond 23 may be between an inner surface of the lower groove 21c and the push head 25. The push head 25 may be fixed to the thermally conductive stacked body 27 through the ceramic bond 23 while accommodated in the lower groove 21c.

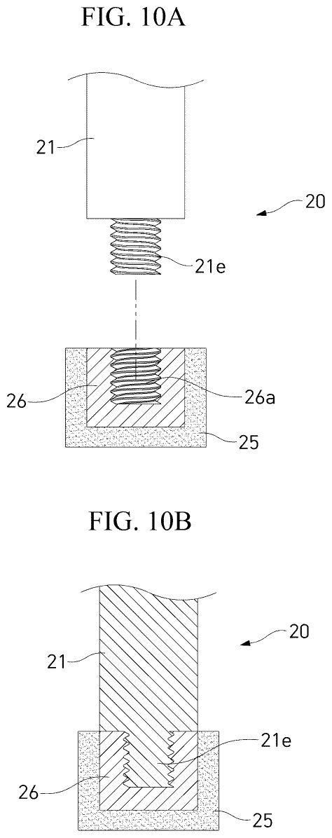

FIGS. 10 to 12 are partial cross-sectional views illustrating still other embodiments of the pushing unit 20. In the pushing unit 20, e.g., as shown in FIGS. 10 to 12, a push head 25 may be mountable on and detachable from the extension rod 21. An adapter 26 may be added to allow the mounting and detachment of the push head.

The adapter 26 may be between the extension rod 21 and the push head 25 and may couple the push head 25 to the extension rod 21. The adapter 26 may be made of the same metal as the extension rod 21.

As shown in FIGS. 10A and 10B, the adapter 26 may be provided between the extension rod 21 and the push head 25. A female thread portion 26a that opens upward may be formed in the adapter 26. For example, the adapter 26 by include a female thread portion 26a. The push head 25 may be fixed to an outer surface of the adapter 26 by a coating method.

In an implementation, a male thread portion 21e may be formed from the lower end portion of the extension rod 21. For example, a male thread portion 21e may extend from the lower end portion of the extension rod 21. The male thread portion 21e may correspond to the female thread portion 26a of the adapter 26. Since the male thread portion 21e and the female thread portion 26a are screw-coupled, relative engagement of the push head 25 to the extension rod 21 may be achieved. FIG. 10A shows a state in which the adapter 26 is detached from the extension rod 21, and FIG. 10B shows a state in which the adapter 26 is coupled to the extension rod 21.

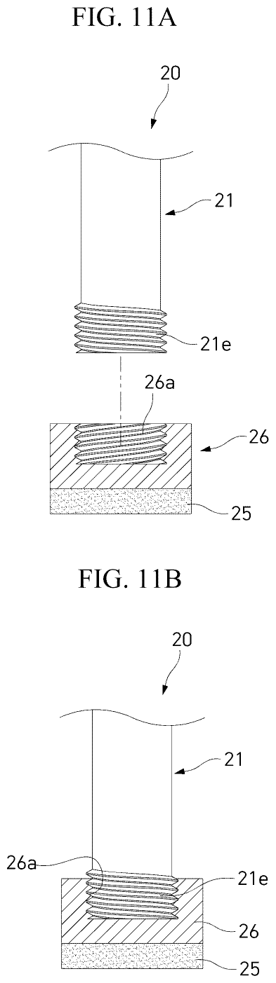

In the case of FIGS. 11A and 11B, the male thread portion 21e is formed on an outer surface of the lower end portion of the extension rod 21. In an implementation, the push head 25 is pressed against and fixed to a bottom surface of the adapter 26. In an implementation, the female thread portion 26a screw-coupled to the male thread portion 21e may be formed in the adapter 26. When the male thread portion 21e and the female thread portion 26a are coupled, a single pushing unit 20 may be formed as shown in FIG. 11B.

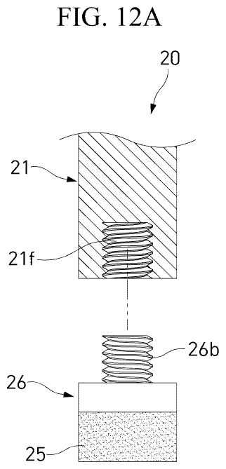

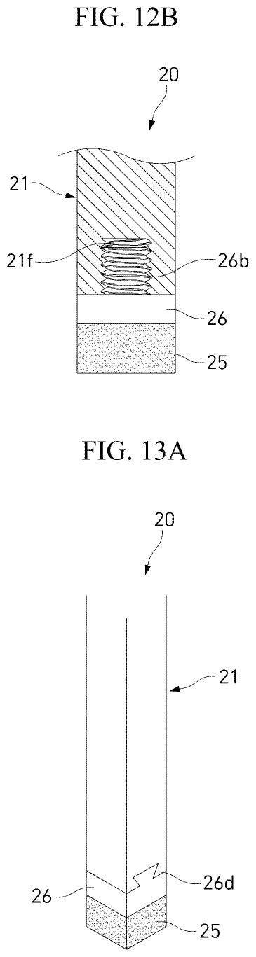

The pushing unit 20, e.g., as shown in FIGS. 12A and 12B, may have a structure in which a female thread portion 21f is formed in the lower end surface of the extension rod 21 and a male thread portion 26b is applied to the adapter 26. For example, a male thread portion 26b may extend from the adapter 26. Since the male thread portion 26b is screw-coupled to the female thread portion 21f, the pushing unit 20 may be formed.

In the pushing units 20 having the types shown in FIGS. 10 to 13, the push head 25 may be connected to the extension rod 21 by the medium of the adapter 26, and the push head 25 may be freely replaced as necessary. In an implementation, the used push head may be detached and the push head 25 with a wider contact area may be installed instead of the used push head. In an implementation, when the above space portion 13b is narrow, a push head 25 with a narrower shape may be replaced.

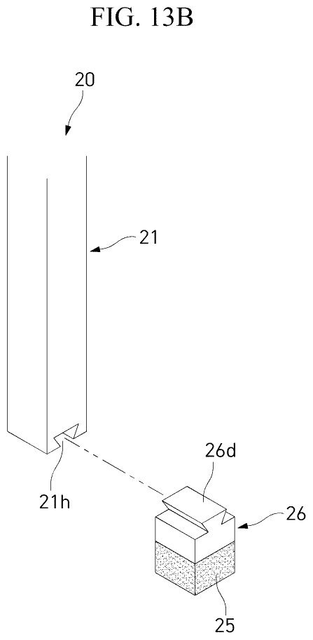

FIGS. 13A and 13B are diagrams illustrating yet another embodiment of the pushing unit 20.

As shown in the drawings, a coupling groove 21h may be formed in the lower end portion of the extension rod 21, and an inserting protrusion 26d may be formed in the adapter 26. The coupling groove 21h may be a dovetail-shaped groove with a predetermined cross-sectional shape in a horizontal direction and may accommodate the inserting protrusion 26d. The pushing unit 20 may be formed by sliding and inserting the inserting protrusion 26d into the coupling groove 21h. In this case, an adhesive may be applied between the inserting protrusion 26d and the coupling groove 21h.

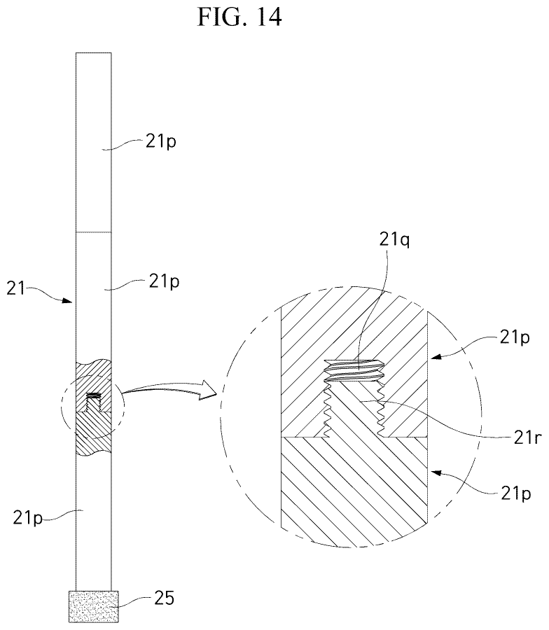

FIG. 14 is a diagram illustrating yet another example of the pushing unit 20.

As shown in FIG. 14, the extension rod 21 may be formed by assembling a plurality of unit rods 21p. The unit rods 21p may be vertical and may be screw-coupled to each other. In an implementation, a male thread portion 21r may be formed in an upper end portion of the unit rod 21p, and a female thread portion 21q may be formed in a lower end portion thereof.

In this way, since the extension rod 21 may be assembled and formed of the plurality of unit rods 21p, a length of the extension rod 21 may be adjusted according to a manufacturing environment of the secondary battery.

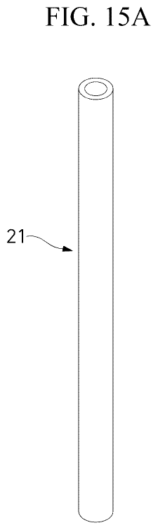

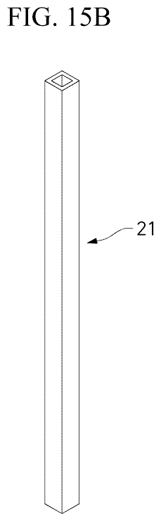

FIGS. 15A and 15B are diagrams illustrating modified embodiments of the extension rod 21 in the pushing unit 20 according to some embodiments of the present disclosure.

As shown in FIG. 15A, the extension rod 21 may have a hollow round rod. For reference, the extension rod 21 described through FIGS. 4 to 13 has a solid structure. In addition, the extension rod 21 of FIG. 15B has a hollow quadrangular rod.

As described above, when the extension rod 21 is formed in a hollow shape, a weight may be light, and in particular, heat inside the extension rod 21 may be discharged upward more rapidly.

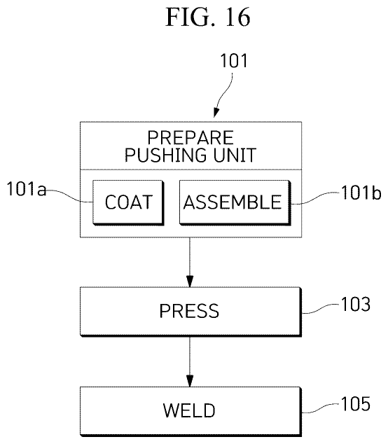

FIG. 16 is a flowchart illustrating a method of manufacturing a secondary battery according to some embodiments of the present disclosure.

As described above, the method of manufacturing a secondary battery according to the present embodiment includes a pushing unit preparation operation (101), a pressing operation (103), and a welding operation (105).

The pushing unit preparation operation (101) is a process of preparing the above-described pushing unit 20. As described above, the pushing unit 20 may include the rod and the electrode pressing part. In an implementation, the rod may be the extension rod 21, and the electrode pressing part may be the push head 25.

In an implementation, the pushing unit preparation operation (101) may include a coating process (101a) or an assembly process (101b). The coating process (101a) and the assembly process (101b) may be performed selectively.

As described with reference to FIGS. 6 to 8, the coating process (101a) may be a process of coating a ceramic material on the end portion of the rod, e.g., the extension rod 21. The ceramic material coated on the extension rod 21 may be one of, e.g., Al₂O₃, ZrO₂, BaTiO₃, Si₃N₄, WC, MgO, or SiC.

In an implementation, the assembly process (101b) may be a process of coupling a molded product manufactured by a sintering molding method to the end portion of the extension rod 21. That is, as shown in FIGS. 9A to 9C, the assembly process (101b) may be a process of fixing the push head 25 to the end portion of the extension rod 21 using the ceramic bond 23. In this case, the thermally conductive stacked body 27 may be applied onto the extension rod 21 in advance.

The thermally conductive stacked body 27 may be a coating layer made of CNTs or DLC. By applying the thermally conductive stacked body 27, thermal conductivity may be improved, and thus thermal damage can be minimized.

The subsequent pressing operation (103) may be a process of inserting the prepared pushing unit 20 into the secondary battery case 13p accommodating the electrode assembly 13a and pressing the second electrode tab 13k of the electrode assembly to the bottom of the case to be in close contact therewith. That is, as shown in FIGS. 3C and 3D, the second electrode tab 13k may be pressed toward the bottom portion 13q of the case 13p by the push head 25 using the actuator 40.

In an implementation, in a state in which the push head 25 presses the second electrode tab 13k, as shown in FIG. 3D, the welding operation (105) may be a process of welding the second electrode tab 13k to the bottom of the case using the welder 50. The welder 50 may be vertically below the push head 25 and may apply welding heat to a central portion of a lower surface of the bottom portion 13q of the case 13p.

By way of summation and review, according to an apparatus and method for manufacturing a secondary battery of the present disclosure, a secondary battery that is stable and has good durability without damage of a pushing unit due to welding heat can be produced. In addition, since the pushing unit is highly durable because it is not damaged or deformed due to the welding heat and does not cause transfer of metal foreign materials, a mass production process can be stabilized and manufacturing productivity can be improved.

A conventional pusher may have a problem of being easily deformed by welding heat during welding. For example, if the electrode tab is repeatedly contacted in a high-temperature environment, the electrode tab may be gradually deformed, resulting in a decrease in flatness of a contact surface, and in the worst cases, a sticking phenomenon in which a metal material of the pusher sticks to a target welding portion may occur. When the metal material of the pusher is transferred to the welding portion, the transferred foreign material may cause a short circuit inside the electrode assembly.

The present disclosure is directed to providing an apparatus and method for manufacturing a secondary battery including a pusher which has no transfer of a metal foreign material due to heat damage and does not cause deformation or loss of flatness.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated.

Accordingly, it will be understood by those of skill in the art that various changes in form and details may be made without departing from the spirit and scope of the present invention as set forth in the following claims.

What is claimed is:

1. An apparatus for manufacturing a secondary battery, the apparatus comprising:
a rod extending in a longitudinal direction; and
a tab pressing portion at an end portion of the rod having a relatively higher heat resistance than the rod.

2. The apparatus as claimed in claim 1, wherein:
the rod includes an extension rod in a form of a rectilinearly extending metal rod; and
the tab pressing portion includes a push head made of a ceramic material fixed to an end portion of the extension rod.

3. The apparatus as claimed in claim 2, wherein the ceramic material includes alumina, zirconia, barium titanate, silicon nitride, tungsten carbide, magnesia, or silicon carbide.

4. The apparatus as claimed in claim 2, wherein the push head is a structure laminated on the end portion of the extension rod in a coating manner.

5. The apparatus as claimed in claim 4, wherein an irregular portion for expanding a close contact area of the push head to the extension rod is at the end portion of the extension rod.

6. The apparatus as claimed in claim 2, wherein the push head is a molded product manufactured by a sintering molding method and is mounted on and fixed to the end portion of the extension rod.

7. The apparatus as claimed in claim 6, wherein a cross section of the extension rod is a circular shape or a polygonal shape.

8. The apparatus as claimed in claim 6, wherein a shape of a bottom surface of the push head is an elliptical shape, a circular shape, or a polygonal shape.

9. The apparatus as claimed in claim 6, wherein the push head is fixed to the extension rod through an adhesive.

10. The apparatus as claimed in claim 9, wherein a thermally conductive stacked body is between the push head and the extension rod.

11. The apparatus as claimed in claim 10, wherein the thermally conductive stacked body includes carbon nanotubes or diamond-like carbon.

12. The apparatus as claimed in claim 6, further including an adapter between the extension rod and the push head configured to couple the push head to the extension rod.

13. The apparatus as claimed in claim 12, wherein the adapter is fixed to the push head and is detachably coupled to the extension rod.

14. The apparatus as claimed in claim 13, wherein the extension rod and the adapter are screw-coupled.

15. The apparatus as claimed in claim 12, wherein:
the end portion of the extension rod includes a coupling groove,
the adapter includes an inserting protrusion, and
the inserting protrusion is in the coupling groove.

16. The apparatus as claimed in claim 2, wherein the extension rod includes a hollow rod or a solid rod.

17. The apparatus as claimed in claim 2, wherein the extension rod includes a plurality of unit rods.

18. A method of manufacturing a secondary battery, the method comprising:
preparing a pushing unit including a rod extending in a longitudinal direction and passing through a space portion of an electrode assembly, and a tab pressing portion positioned in an end portion of the rod having a relatively higher heat resistance than the rod and pressing an electrode tab of the electrode assembly to a welding target surface and bringing the electrode tab into close contact with the welding target surface;
inserting the pushing unit into a case of the secondary battery accommodating the electrode assembly to press the electrode tab of the electrode assembly to be in close contact with a bottom of the case; and
welding the electrode tab to the bottom of the case.

19. The method as claimed in claim 18, wherein:
the tab pressing portion is made of a ceramic material; and
preparing the pushing unit includes coating the end portion of the rod with the ceramic material.

20. The method as claimed in claim 18, wherein:
the tab pressing portion is made of a ceramic material; and
preparing the pushing unit includes coupling a molded product manufactured by a sintering molding method to the end portion of the rod.
